(19) United States
(12) Patent Application Publication
(10) Pub. No.: US 2026/0056340 A1
(43) Pub. Date: Feb. 26, 2026

(54) GENERATIVE ARTIFICIAL INTELLIGENCE-ENABLED MULTIMODAL PROMPT QUERYING ON SUBSURFACE MODELS

(71) Applicant: Schlumberger Technology Corporation, Sugar Land, TX (US)

(72) Inventors: Priya Mishra, Sunnyvale, CA (US); Anatoly Aseev, Redwood City, CA (US); Salma Benslimane, Menlo Park, CA (US); Prasham Sheth, Calgary (CA)

(21) Appl. No.: 19/302,189

(22) Filed: Aug. 18, 2025

Related U.S. Application Data
(60) Provisional application No. 63/686,426, filed on Aug. 23, 2024.

(51) Int. Cl. G01V 1/34; E21B 47/12; G06T 7/00

(52) U.S. Cl. CPC G01V 1/345; E21B 47/12; G06T 7/001

(57) ABSTRACT

A method for performing generative artificial intelligence (AI)-enabled multimodal prompt querying on subsurface models includes receiving input data. The input data includes seismic data that represents a subsurface formation. The method also includes generating a plurality of images based upon the input data. The method also includes extracting first image embeddings based upon the plurality of images. The method also includes storing the first image embeddings in a vector database. The method also includes receiving an input prompt. The method also includes extracting a prompt embedding based upon the input prompt. The method also includes storing the prompt embedding in the vector database. The method also includes identifying a similar one of the images based upon the prompt embedding.

### CROSS-REFERENCE TO RELATED APPLICATIONS

This application claims priority to and the benefit of U.S. Provisional Ser. No. 63/686,426, filed on Aug. 23, 2024, which is incorporated by reference in its entirety.

### BACKGROUND

Analysis of subsurface models is currently performed manually by a seismic interpreter who spends long hours scanning seismic cubes. Because the solution is manual, it is prone to human errors and limited to human experience and expertise. There have been advancements recently in generative artificial intelligence (AI), which may remove or eliminate the human element. For example, language models like ChatGPT®, Gemini®, and Claud 3® may now perform multimodal work that uses vision, audio, speech, video etc. to provide multi-modal capabilities. However, these models, when directly tested with domain-specific images, don't generalize well.

Therefore, what is needed is an improved generative AI-enabled multimodal prompt querying on subsurface models.

### SUMMARY

A method for performing generative artificial intelligence (AI)-enabled multimodal prompt querying on subsurface models is disclosed. The method includes receiving input data. The input data includes seismic data that represents a subsurface formation. The method also includes generating a plurality of images based upon the input data. The method also includes extracting first image embeddings based upon the plurality of images. The method also includes storing the first image embeddings in a vector database. The method also includes receiving an input prompt. The method also includes extracting a prompt embedding based upon the input prompt. The method also includes storing the prompt embedding in the vector database. The method also includes identifying a similar one of the images based upon the prompt embedding.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving input data. The input data includes seismic data that represents a subsurface formation. The seismic data includes a plurality of 3D cubes. The operations also include generating a plurality of images based upon the input data. The images include 2D slices of the 3D cubes. The operations also include extracting first image embeddings based upon the images. The first image embeddings are extracted using a multimodal foundation model. The operations also include storing the first image embeddings in a vector database. The operations also include receiving an input prompt. The operations also include extracting a prompt embedding based upon the input prompt. The operations also include storing the prompt embedding in the vector database. The operations also include identifying a similar one of the images based upon the prompt embedding. Identifying the similar image includes determining a distance between the prompt embedding and each of the first image embeddings. The similar image corresponds to the first image embedding with the smallest distance.

A non-transitory computer-readable medium is also disclosed. The medium stores instructions that, when executed by one or more processors of a computing system, cause the computing system to perform operations. The operations include receiving input data. The input data includes seismic data that represents a subsurface formation. The seismic data includes a plurality of 2D slices or 3D cubes. The operations also include generating a plurality of images based upon the input data. The images include 2D slices of the 3D cubes. The operations also include extracting first image embeddings based upon the images. The first image embeddings are extracted using a multimodal foundation model. The multimodal foundation model is fine-tuned based upon relevant domain data. The multimodal foundation model uses contrastive language-image pre-training (CLIP). The operations also include storing the first image embeddings in a vector database. The operations also include receiving an input prompt. The input prompt includes an input text query about the subsurface formation or an input 2D slice. The operations also include extracting a prompt embedding based upon the input prompt. The prompt embedding includes a text embedding when the input prompt is the input text query. The prompt embedding includes a second image embedding when the input prompt is the input 2D slice. The prompt embedding is extracted using the multimodal foundation model. The operations also include storing the prompt embedding in the vector database. The operations also include identifying a similar one of the images based upon the prompt embedding. Identifying the similar image includes determining a distance between the prompt embedding and each of the first image embeddings. The similar image corresponds to the first image embedding with the smallest distance. The operations also include automatically retrieving additional seismic data with seismic characteristics that are similar to seismic characteristics in the similar image. The additional seismic data is automatically retrieved for quality control, data cleaning, further interpretation, or answering a question. The further interpretation includes seismic object detection, segmentation, and mapping for subsurface resources exploration and development. The additional seismic data is introduced into an image-to-text model to facilitate answering the question to provide a description of the similar image.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates an example of a table with a filename of an image and associated caption, according to an embodiment.

FIG. 3 illustrates a flowchart of a method for performing generative artificial intelligence (AI)-enabled multimodal prompt querying on subsurface models, according to an embodiment.

FIG. 4 illustrates a schematic view of an architecture design of seismic section retrieval using text prompts, according to an embodiment.

FIG. 5 illustrates an application using a seismic model to output images/slices based on input text prompts, according to an embodiment.

FIG. 6 illustrates an application using a geological model to output images/slides based on input text prompts, according to an embodiment.

FIGS. 7A and 7B illustrate an image and a table showing the solution demonstrating different clusters of images embedding depicting the clusters, according to an embodiment.

FIGS. 8A and 8B illustrate an image and a table showing the different clusters of image embeddings and the query, according to an embodiment.

FIG. 9A-9C illustrate images of multimodal search result outputs based on input text prompts, according to an embodiment.

FIG. 10 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining”or “in response to detecting,”depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

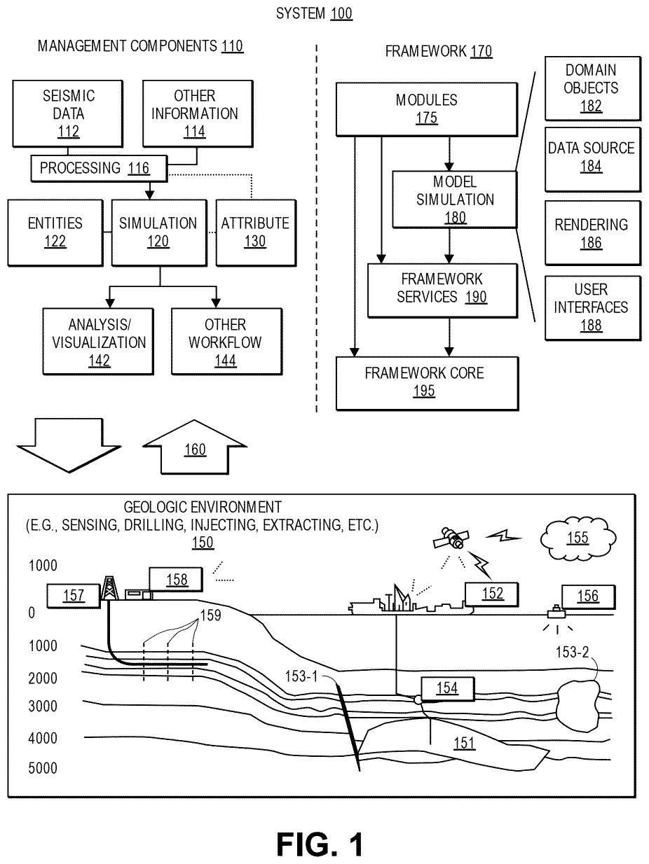

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®. NET® framework (Redmond, Washington), which provides a set of extensible object classes. In the. NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

As an example, the simulation component 120 may include one or more features of a simulator such as SYMMETRY™ software (SLB, Houston, Texas). More particularly, SYMMETRY™ may process workflows in a single integrated environment with accurate thermodynamic fluid representation and consistent modeling across multiple disciplines including process, production, and HSE. The simulator integrates steady-state and transient (e.g., dynamic) analyses that can be tailored for each domain. This approach enables users to optimize processes in upstream, midstream, and downstream sectors while maximizing profits and minimizing capital expenditures. It may also help reduce emissions, energy consumption, and waste.

As an example, the simulation component 120 may include one or more features of a simulator such as PIPESIM™ (SLB, Houston, Texas). More particularly, PIPESIM™ is steady-state multiphase flow simulator that incorporates the three areas of flow modeling: multiphase flow, heat transfer and fluid behavior.

As an example, the simulation component 120 may include one or more features of a simulator such as OLGA™ (SLB, Houston, Texas). More particularly, OLGA™ is a dynamic multiphase flow simulator that models transient flow (e.g., time-dependent behaviors) to maximize production potential. Transient modeling is a component for feasibility studies and field development design. Dynamic simulation is useful in deep water and is used in both offshore and onshore developments to investigate transient behavior in pipelines and wellbores. Transient simulation with the OLGA™ simulator provides an added dimension to steady-state analysis by predicting system dynamics, such as time-varying changes in flow rates, fluid compositions, temperature, solids deposition, and operational changes.

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages. NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

Gen AI-Enabled Multi-Modal Prompt Querying on Subsurface Models The present disclosure includes a system and method that provide an automatic solution that leverages multimodal generative AI and produce outputs within seconds. The solution uses a multimodal model where a user has the ability to scan images and/or 3D cubes automatically and retrieve outputs based on user queries.

The vision-language foundation models, once trained, may capture the relationship between the text and image encoding, providing multi-modal embedding alignment. The method may then use an image-text foundation model such as contrastive language-image pre-training (CLIP), but it is not limited to this foundation model and can use other vision-language models. CLIP is a language vision model where the user, based on input text prompts, can retrieve relevant images. This model is currently trained on generic datasets and performs well when tested on similar data; however, it fails to generalize well on some domain datasets. For it to perform better on domain datasets, a subsurface domain specific image and captions dataset may be created, and the model may be retrained with it.

When the user enters the 3D cube into the system, it may first extract the 2D slides/images from these images. Based on the input text prompt, the system produces the subset of these images. It further stores these images in a vector database, which helps in fast retrieval of data. This is an automatic system, and it eliminates the time and effort which the seismic interpreter would spend when performing this activity manually

The input prompting may be also multi-modal and can include images as well. This is useful in the case where the seismic interpreter has a set of slices/images for which it wants to query other similar images. A simple example of what a user can ask this model may be:
A seismic section with low frequency
A seismic section with high frequency and high noise

The proposed solution performs text-image retrieval where the users can automatically retrieve the seismic 2D images based on the input text prompt from the 3D cubes. Subsurface domain experts can directly use the application using a semantically plausible way, similar to how the general public uses GPT-4 or Gemini, and, as a result, extract knowledge from the subsurface data.

### Data Creation

One element of the solution is collecting sufficient data for training such a model. The data may include subsurface images (e.g., models) and corresponding text (e.g., captions, descriptions, question-answers, etc.).

### Example Table

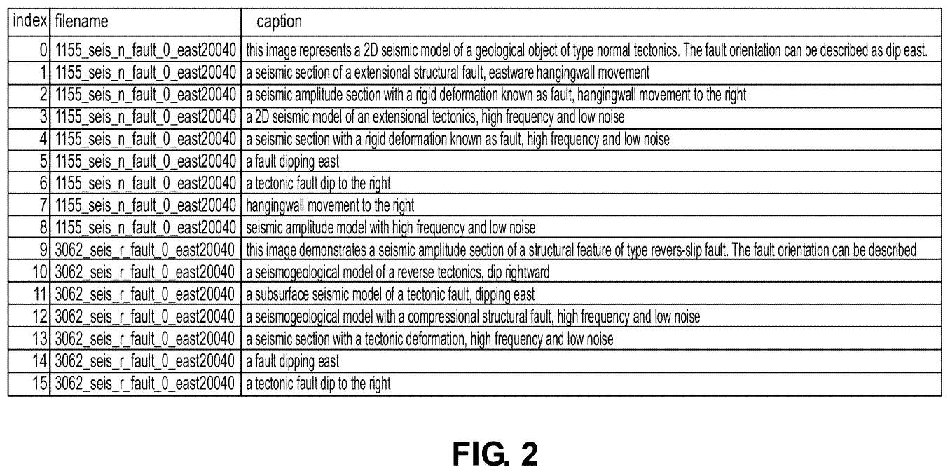

FIG. 2 illustrates an example of a table with a filename of an image and associated caption, according to an embodiment. To generate text-model pairs for training, an open-source PyNoddy tool may be used. PyNoddy is a kinematic forward modeling tool that generates structurally complex geological models in a stochastic and probabilistic manner. A synthetic dataset may be generated that includes kinematically consistent geologic 2D models and further seismic models with classes such as fault, fold, tilt, frequency, and noise. Assorted captions may be prepared using Monte Carlo sampling to describe features in the corresponding geological models and seismic data.

### Model Building

As mentioned above, in one example, the system and method may use a vision language model (e.g., CLIP). However, there are different models, training techniques, and loss functions that could also be used. CLIP is a neural network trained on a variety of (e.g., image, text) pairs. It can be instructed in natural language to predict the most relevant text snippet, given an image, without directly optimizing for the task, similarly to the zero-shot capabilities of GPT-2 and 3. CLIP uses a contrastive learning approach where the CLIP jointly trains an image encoder and a text encoder to predict the correct pairings of a batch of (e.g., image, text) training examples. At test time, the learned text encoder synthesizes a zero-shot linear classifier by embedding the names or descriptions of the target dataset's classes (e.g., From Clip Paper).

In experiments, the model was trained on several datasets: 1. Geological dataset and 2. seismic dataset. The models and the framework may be expanded to other relevant datasets without a loss of generalizability to better cater to the application (e.g., a subset of the dataset on the client's location).

### ML Pipeline Design

An architecture may be designed and used, which can take control of the flow of the data from the 3D cube. First, the 2D slices/images may be extracted from the 3D cube. Those images may then be sent to the trained CLIP vision encoder from which the embeddings of the images are extracted. These vector embeddings of the images, along with actual images, captions details, etc. as the metadata may then be stored in a (e.g., chroma DB) vector database.

The user can then input some text prompts, which are then converted into text embeddings from the CLIP text encoder. The system may find the images similar to this text description by finding the distance between the text and image embedding vectors. At the end, it may output a subset of seismic 2D slices/images.

### Example Method and Architecture Design

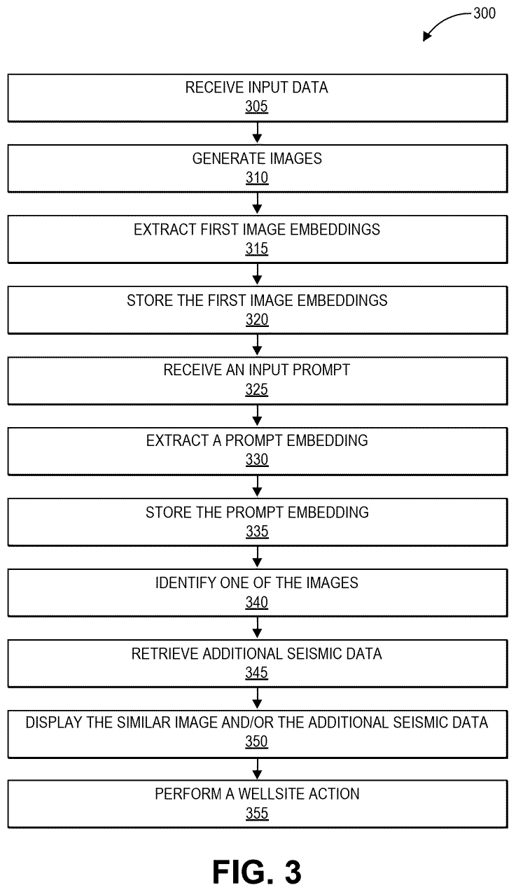

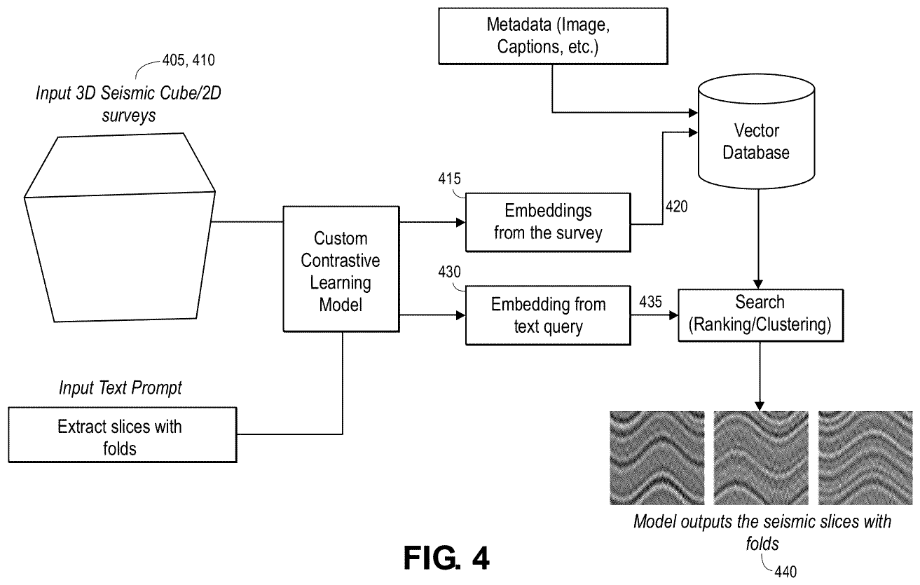

FIG. 3 illustrates a flowchart of a method 300 for performing generative artificial intelligence (AI)-enabled multimodal prompt querying on subsurface models, according to an embodiment. An illustrative order of the method 300 is provided below; however, one or more portions of the method 300 may be performed in a different order, simultaneously, repeated, or omitted. At least a portion of the method 300 may be performed with a computing system (described below). FIG. 4 illustrates a schematic view of an architecture design of seismic section retrieval using text prompts that corresponds to the flowchart in FIG. 3, according to an embodiment.

The method 300 may include receiving input data, as at 305. This is also shown at 405 in FIG. 4. The input data may be or include seismic data that represents a subsurface formation. The input data may be or include a plurality of 2D slices or 3D cubes.

The method 300 may also include generating a plurality of images based upon the input data, as at 310. This is also shown at 410 in FIG. 4. The images may be or include 2D slices of the 3D cubes.

The method 300 may also include extracting first image embeddings based upon the images, as at 315. This is also shown at 415 in FIG. 4. The first image embeddings may be extracted using a multimodal foundation model. The multimodal foundation model may be fine-tuned based upon relevant domain data such as seismic images, seismic cubes, 3D measurements representing the logs, or a combination thereof. The multimodal foundation model may use contrastive language-image pre-training (CLIP).

The method 300 may also include storing the first image embeddings in a vector database, as at 320. This is also shown at 420 in FIG. 4. Thus, the first image embeddings may be converted to and/or stored as vectors.

The method 300 may also include receiving an input prompt, as at 325. This is also shown at 425 in FIG. 4. The input prompt may be or include an input text query about the subsurface formation or an input 2D slice.

The method 300 may also include extracting a prompt embedding based upon the input prompt, as at 330. This is also shown at 430 in FIG. 4. The prompt embedding may be or include a text embedding when the input prompt is the input text query. The prompt embedding may be or include a second image embedding when the input prompt is the input 2D slice. The prompt embedding may be extracted using the multimodal foundation model.

The method 300 may also include storing the prompt embedding in the vector database, as at 335. This is also shown at 435 in FIG. 4. Thus, the prompt embedding may be converted to and/or stored as a vector.

The method 300 may also include identifying a similar one of the images based upon the prompt embedding, as at 340. This is also shown at 440 in FIG. 4. Identifying the similar image may include determining a distance between the prompt embedding and each of the first image embeddings. The similar image corresponds to the first image embedding with the smallest distance.

The method 300 may also include automatically retrieving additional seismic data, as at 345. The additional seismic data may have seismic characteristics that are similar to seismic characteristics in the similar image. The additional seismic data may be automatically retrieved for quality control, data cleaning, further interpretation, or answering a question. The further interpretation may include seismic object detection, segmentation, and/or mapping for subsurface resources exploration and development. The additional seismic data may be introduced into an image-to-text model to facilitate answering the question to provide a description of the similar image.

The method 300 may also include displaying the similar image and/or the additional seismic data, as at 350.

The method 300 may also include performing a wellsite action, as at 355. The wellsite action may be performed in response to the similar image or the additional seismic data. The wellsite action may be or include generating and/or transmitting a signal that recommends, instructs, or causes a physical action to occur at a wellsite. Examples of the physical action may be or include selecting where to drill a wellbore, drilling the wellbore, varying a weight and/or torque on a drill bit that is drilling the wellbore, varying a drilling trajectory of the wellbore, or varying a concentration and/or flow rate of a fluid pumped into the wellbore. In another embodiment, the similar image or the additional seismic data may be used to increase a speed of subsequent exploration tasks.

Storing the data in Vector Database

The image embedding generated through the vision encoder may be saved into a vector database for fast retrieval of images. The database is further used to store the actual images and textual captions for each of the image embeddings. The database storage helps to maintain the relationship between the image and image embedding and further retrieve the images at run time based on the input text prompt. In an example, the system may use the ChromaDB vector database for easy storage and fast retrieval.

### An Application for Users

An application may provide direct access for the end users. In this application, the user can query the vector database to fetch the images based on input text prompts. The application produces results within seconds, and it may be implemented for both geological and seismic models. In an example, the application may have a direct use case in the Petrel system which may help the seismic interpreter to scan the seismic 3D cube automatically, thereby reducing the amount of time spend to manually scan the seismic cubes.

### Example Applications

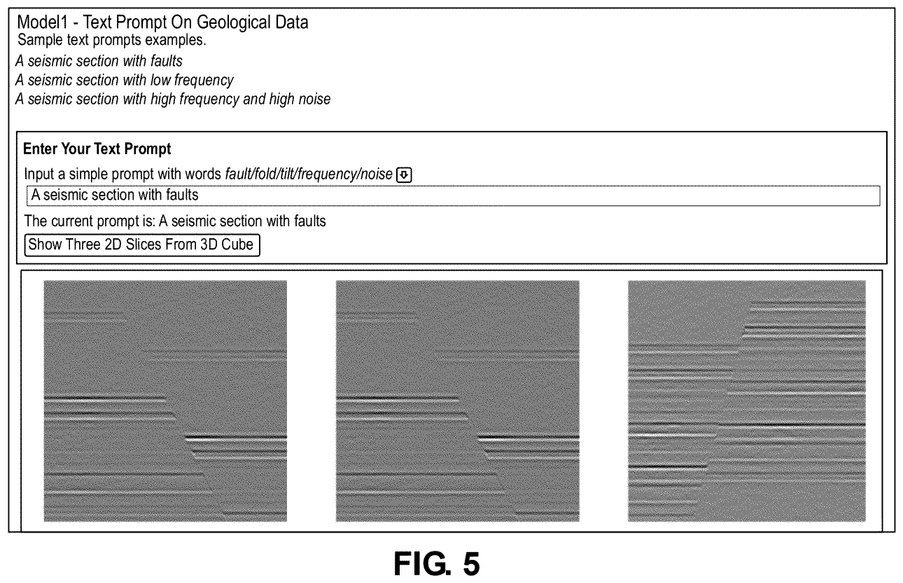

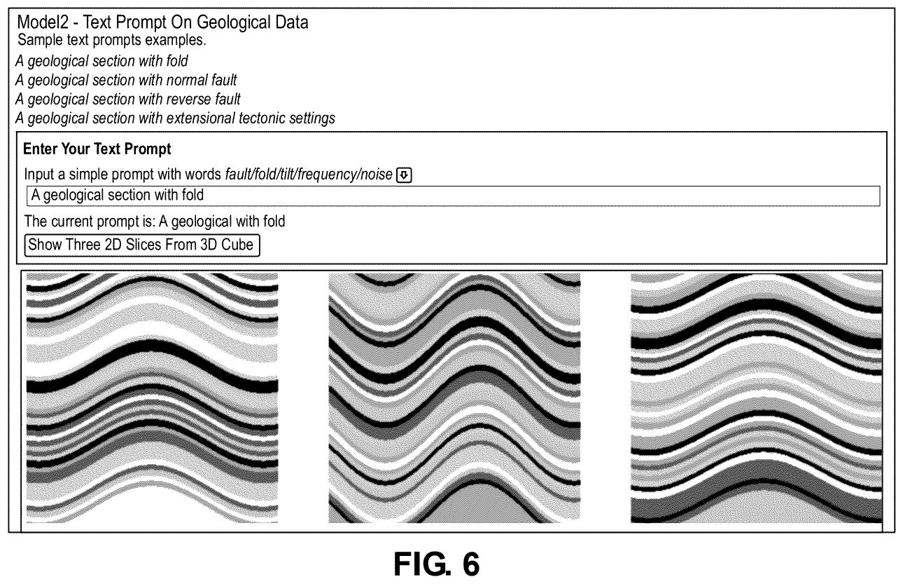

FIG. 5 illustrates an application using a seismic model to output images/slices based on input text prompts, according to an embodiment. More particularly, FIG. 5 illustrates the top 3 results to the query “retrieve normal fault with high frequency and having less noise. ” FIG. 6 illustrates an application using a geological model to output images/slides based on input text prompts, according to an embodiment. More particularly, FIG. 6 illustrates the top 3 results to the query “show me pictures of fold with more noise.”

### Advance Data Retrieval System

The conventional text-image retrieval method implemented in VLMs leverages the similarity search and uses method to find the top k similar images to the input prompt. There is no way to retrieve the relevant images of interest. To overcome this, the method 300 described herein implements a unique strategy to search relevant features and exclude irrelevant features. More particularly, the method understands the images'embeddings and creates clusters of them which are differentiated based on seismo-graphic features.

For example, density-based spatial clustering of applications with noise (DBSCAN) clustering techniques may be used to cluster the image embeddings. The implemented clustering algorithm parameters may be tuned to find the best segregation of seismo-graphic features. For a given query input, the method can find the cluster closest to the query and can deliver the top clusters associated with the given input textual query.

In an example, given a test dataset of 8008 images with different features of fold, fault and tilt, the method 300 was able to clusters the image embeddings and segregate clusters of different features of folds and faults.

### Different Clusters From the Implemented Solution

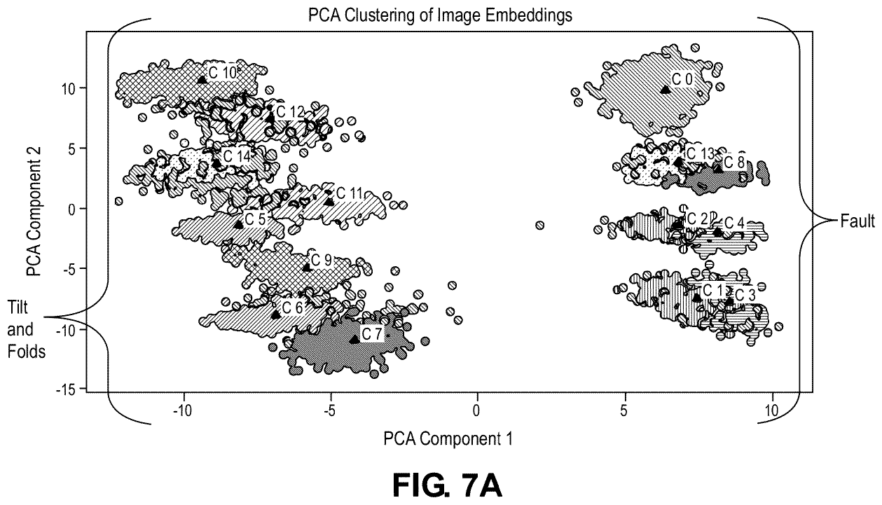

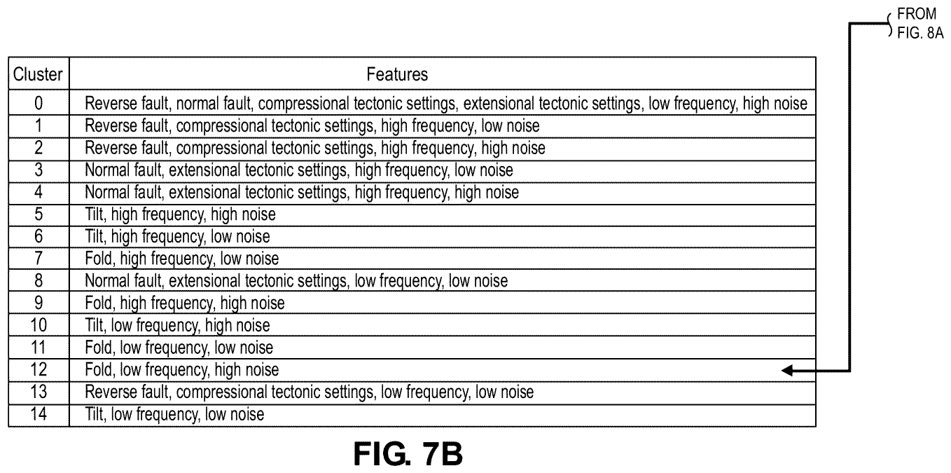

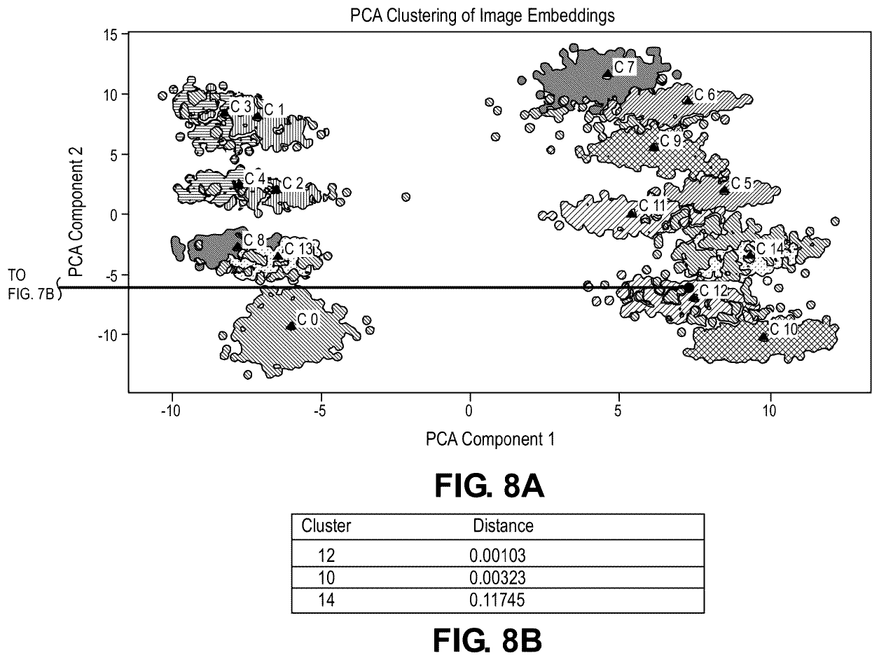

FIGS. 7A and 7B illustrate an image and a table showing the solution demonstrating different clusters of images embedding depicting the clusters, and FIGS. 8A and 8B illustrate an image and a table showing the different clusters of image embeddings and the query, according to an embodiment. More particularly, FIGS. 8A and 8B show an example multimodal search result depicting a visual representation of different clusters and the given query prompt. FIGS. 5, 7A, and 7B are results in response to the same query (i.e., “retrieve normal fault with high frequency and having less noise”), and FIGS. 6, 8A, and 8B are results in response to the same query (i.e., “show me pictures of fold with more noise”). FIGS. 7A, 7B, 8A, and 8B merely represent a different approach (i.e., clustering) than FIGS. 5 and 6 (i.e., ranking).

### Multimodal Search Results Displaying Output Images From the First Cluster Based on Given Input Text Prompt

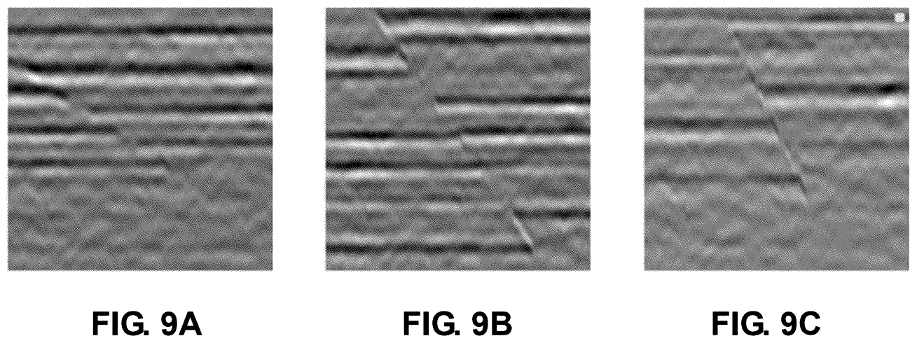

FIG. 9A-9C illustrate images of multimodal search result outputs based on input text prompts, according to an embodiment. Subsurface characterization, including seismic data quality control (QC), processing, and interpretation, is a visual task. Users may spend time screening large masses of seismic data, looking for specific visual features that may be relevant for further seismic interpretation or decisions. For example, it is well known that the Norwegian Petroleum Directorate's seismic data includes a multitude of seismic 2D and 3D surveys acquired across different petroleum basins in the Norwegian Continental Shelf. To start seismic interpretation, users may skim tens of 3D seismic cubes to understand their quality. The system and method described herein can identify seismic sections with low noise levels or other vital characteristics for a seismic interpreter if prompted to “show seismic sections with low noise.”

Another example is if a seismic interpreter is looking for a specific structural or stratigraphic feature on a 3D seismic cube that is relevant for petroleum exploration. Again, a conventional workflow is to use the “intersection player” in the Petrel interpretation window, click the “Next” button, visualize the 2D slice in a specified direction, and then look for a specific seismic record that characterizes a desired feature. This workflow is cumbersome and time-consuming. The system and method described herein can identify seismic sections with the desired feature using the semantically plausible prompt. For instance, “show seismic slices with DHIs” or “show seismic slices with a fault dipping east.”

The system and method are automatic and thus save time and human effort. They may produce results within seconds once the image embeddings are stored in the vector database. The user can then test and query different prompts according to their desires. Hence, this helps in faster analysis of 3D cubes.

### Machine Learning System for Multimodal Seismic Search

As discussed above, conventional seismic data quality control methods involve manually scanning large volumes of 3D and 2D data. However, manual scanning faces challenges such as long scanning hours, susceptibility to human error, and limitations due to the individual expertise of seismic interpreters. One objective is to address these limitations by developing a comprehensive solution that automates the manual process. This solution does not rely solely on individual expertise but also leverages a combination of data-driven insights and domain knowledge. The method 300 includes a machine-learning (ML)-driven approach in which domain experts can use semantic, plausible ways to search all seismic data associated with input prompt queries.

The method 300 leverages recent cutting-edge advancements in generative AI algorithms, such as vision-language models (VLMs), and introduces an innovative approach to multimodal search. This is achieved through a custom contrastive learning neural network model that bridges the gap between semantic seismic concepts and their visual representation. The solution learns the embeddings of different modalities (e.g., textual and visual) and projects them in the same latent space. Hence, enabling a fast and robust text-to-image retrieval and search. By leveraging the custom-trained VLMs on seismic survey data, the model can perform better than an off-the-shelf model and learn the semantic meaning of embeddings.

In the method 300, seismic interpreters or geoscientists can search for features of interest in large seismic cubes by asking simple questions. The method 300 leverages vector databases to store and effortlessly extract insights from complex seismic data within a few seconds. It implements a unique strategy to search relevant features and exclude irrelevant features by developing clusters of seismo-graphic features. In the end, the method 300 can produce results based on different techniques like ranking and clustering.

The method 300 provides an automated solution for analyzing complex seismic 3D cubes and surveys. The method 300 reduces and unifies seismic data interpretation time. The method 300 also understands the different modalities and promptly answers the queries

### EAGE

As described above, the conventional approach for seismic data quality control, which is identifying subsurface geological features and exploration mapping, involves manually scanning large volumes of 3D and 2D data, and displaying seismic slices one by one in seismic interpretation software. This approach is inefficient, subjective, and time consuming, as scanning terabytes of data takes weeks or months of the seismic interpreter's time. The method 300 described above includes a machine-learning (ML) driven approach where domain experts can use semantic, plausible ways to search seismic data associated with the prompt queries. The method 300 is based on advanced generative AI algorithms such as vision language models (VLMs), especially using multimodal contrastive learning, which has the unique capability of understanding and capturing the relationship between the seismic visual representation (image data) and their semantic meaning (textual data).

A multimodal search, when performed, can understand the context behind the textual prompt and output the relevant images based on the prompt, as shown in FIG. 4. Searching or querying the seismo-geological features of interest from a large seismic dataset can reduce the laborious task of manually scanning 3D cubes or 2D surveys performed by seismic interpreters, hence, decreasing the long hours of manual scanning. Furthermore, the effectiveness of the analysis would not be bound by the individual interpreter's level of expertise, potentially leading to inconsistencies and limitations in the depth and accuracy of the analysis.

The method 300 is a multimodal search that bridges the gap between semantic seismic concepts and their visual representation. Beyond a regular semantic search, where the focus is to learn the context/text meaning, the method 300 implements a multimodal search in which a custom contrastive learning neural network model learns the embeddings of different modalities (e.g., textual and visual) and enables a quick and robust text-to-image retrieval and search. The method 300 introduces a new paradigm for searching features of interest in large seismic data by text and enables geoscientists to effortlessly extract insights from large complex seismic data by asking simple questions.

The contrastive learning approaches in ML extract vector representations of data, known as embeddings, by positioning similar samples together and dissimilar samples apart in the latent space. There are different models implementing contrastive learning, for example, SimCLR, which focuses on learning visual representations of images, while others like the CLIP model focuses on learning visual representations of both image and text and are of interest to us. These contrastive learning image-text models are trained on generic images and captions from public datasets and lack training examples from our domain-specific datasets (e.g., seismic surveys). Although these models perform accurately on public datasets, their performance decreases when assessed on seismic images, highlighting their limited adaptability to new domains.

Therefore, the method 300 builds upon a multimodal contrastive learning model adapted to seismic images. By training on a domain-specific seismic synthetic dataset, including different tectonostratigraphic seismic set features along with textual semantic captions, the trained model learns the underlying relationship between seismic images and textual representations in the latent space. The multimodal search then uses the aligned image and textual embeddings from the trained model in the common latent space to retrieve relevant 2D images.

To conduct a text-to-image search, an input textual query from the user is received that specifies the seismic feature of interest and a large 3D seismic cube for the search. The workflow of the multimodal search includes the following steps: deconstructing the 3D seismic cube into individual 2D images, building a vector database of the 2D slices with projected embeddings generated by the trained multimodal contrastive model, projecting the input query into the embedding space from the same trained model, then using the shared latent space and clustering methods to extract the closest 2D image to the input query.

In an example, the method 300 created a sample query dataset of 10 different kinds of prompts including 13 main classes of seismo-geological features. The synthetic test image dataset contained 8008 unique images. A top k (k=3) search was performed to identify the top k answers based on the similarity score, and provided a precision evaluation metric of 0.9. The results demonstrate value from the implemented search query system that leverages trained contrastive models with a vector store database to enable faster reliable search.

Thus, the new multimodal search capabilities reduce and unify seismic data interpretation time. By leveraging advanced generative artificial intelligence contrastive models, the method 300 demonstrates the potential to efficiently correlate seismic images and textual descriptions, enabling rapid and accurate searches. This methodology shows great promise in streamlining the workflow for geologists and seismic interpreters, ultimately leading to more informed decision-making.

### Exemplary Computing System

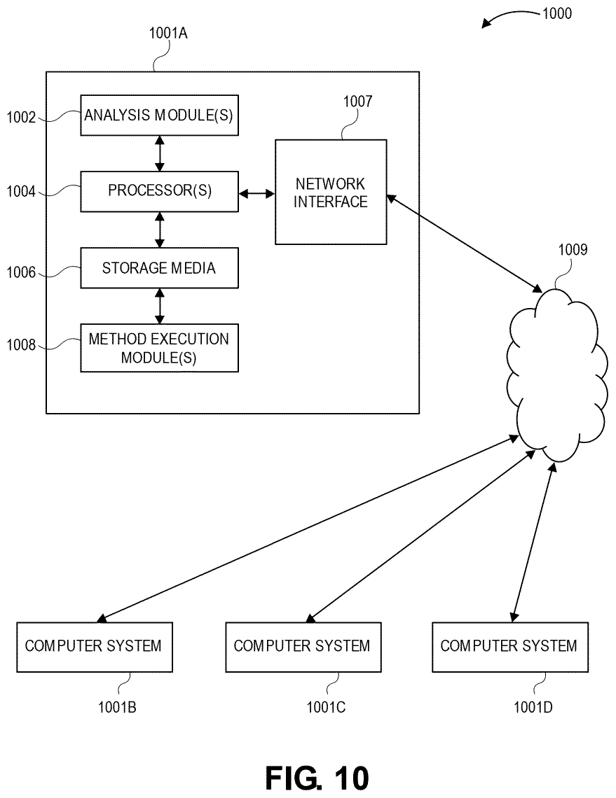

In some embodiments, the methods of the present disclosure may be executed by a computing system. FIG. 10 illustrates an example of such a computing system 1000, in accordance with some embodiments. The computing system 1000 may include a computer or computer system 1001A, which may be an individual computer system 1001A or an arrangement of distributed computer systems. The computer system 1001A includes one or more analysis modules 1002 that are configured to perform various tasks according to some embodiments, such as one or more methods disclosed herein. To perform these various tasks, the analysis module 1002 executes independently, or in coordination with, one or more processors 1004, which is (or are) connected to one or more storage media 1006. The processor(s) 1004 is (or are) also connected to a network interface 1007 to allow the computer system 1001A to communicate over a data network 1009 with one or more additional computer systems and/or computing systems, such as 1001B, 1001C, and/or 1001D (note that computer systems 1001B, 1001C and/or 1001D may or may not share the same architecture as computer system 1001A, and may be located in different physical locations, e.g., computer systems 1001A and 1001B may be located in a processing facility, while in communication with one or more computer systems such as 1001C and/or 1001D that are located in one or more data centers, and/or located in varying countries on different continents).

A processor may include a microprocessor, microcontroller, processor module or subsystem, programmable integrated circuit, programmable gate array, or another control or computing device.

The storage media 1006 may be implemented as one or more computer-readable or machine-readable storage media. Note that while in the example embodiment of FIG. 10 storage media 1006 is depicted as within computer system 1001A, in some embodiments, storage media 1006 may be distributed within and/or across multiple internal and/or external enclosures of computing system 1001A and/or additional computing systems. Storage media 1006 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 1000 contains one or more method execution module(s) 1008. In the example of computing system 1000, computer system 1001A includes the method execution module 1008. In some embodiments, a single method execution module may be used to perform some aspects of one or more embodiments of the methods disclosed herein. In other embodiments, a plurality of method execution modules may be used to perform some aspects of methods herein.

It should be appreciated that computing system 1000 is merely one example of a computing system, and that computing system 1000 may have more or fewer components than shown, may combine additional components not depicted in the example embodiment of FIG. 10, and/or computing system 1000 may have a different configuration or arrangement of the components depicted in FIG. 10. The various components shown in FIG. 10 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 1000, FIG. 10), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for performing generative artificial intelligence (AI)-enabled multimodal prompt querying on subsurface models, the method comprising:
receiving input data, wherein the input data comprises seismic data that represents a subsurface formation;
generating a plurality of images based upon the input data;
extracting first image embeddings based upon the plurality of images;
storing the first image embeddings in a vector database;
receiving an input prompt;
extracting a prompt embedding based upon the input prompt;
storing the prompt embedding in the vector database; and
identifying a similar one of the images based upon the prompt embedding.

2. The method of claim 1, wherein the input data comprises a plurality of 2D slices or 3D cubes.

3. The method of claim 2, wherein the images comprise 2D slices of the 3D cubes.

4. The method of claim 1, wherein the first image embeddings are extracted using a multimodal foundation model.

5. The method of claim 4, wherein the multimodal foundation model is fine-tuned based upon relevant domain data.

6. The method of claim 5, wherein the multimodal foundation model is a contrastive language-image pre-training (CLIP) model.

7. The method of claim 1, wherein the input prompt comprises an input text query about the subsurface formation, and wherein the prompt embedding comprises a text embedding.

8. The method of claim 1, wherein the input prompt comprises an input 2D slice, wherein the prompt embedding comprises a second image embedding, and wherein the second image embedding is extracted using a multimodal foundation model.

9. The method of claim 1, wherein the similar image comprises one or more similar images, wherein identifying the one or more similar images comprises determining distances between the prompt embedding and each of the first image embeddings, and wherein the one or more similar images correspond to the first image embeddings with smallest distances.

10. The method of claim 1, wherein the similar image comprises one or more similar images, and wherein the one or more similar images are identified using an approximate similarity computation.

11. The method of claim 1, further comprising automatically retrieving additional seismic data with seismic characteristics that are similar to seismic characteristics in the similar image, wherein the additional seismic data is automatically retrieved for further interpretation, wherein the further interpretation comprises seismic object detection, segmentation, and mapping for subsurface resources exploration and development, and wherein the additional seismic data is introduced into an image-to-text model to facilitate answering a question to provide a description of the similar image.

12. The method of claim 11, further comprising displaying the similar image and/or the additional seismic data.

13. The method of claim 11, further comprising performing a wellsite action in response to the similar image or the additional seismic data, wherein the wellsite action comprises generating and/or transmitting a signal that recommends, instructs, or causes a physical action to occur at a wellsite, and wherein the physical action comprises selecting where to drill a wellbore, drilling the wellbore, varying a weight and/or torque on a drill bit that is drilling the wellbore, varying a drilling trajectory of the wellbore, or varying a concentration and/or flow rate of a fluid pumped into the wellbore.

14. A computing system, comprising:
one or more processors; and
a memory system comprising one or more non-transitory computer-readable media storing instructions that, when executed by at least one of the one or more processors, cause the computing system to perform operations, the operations comprising:
receiving input data, wherein the input data comprises seismic data that represents a subsurface formation, and wherein the seismic data comprises a plurality of 3D cubes;
generating a plurality of images based upon the input data, wherein the images comprise 2D slices of the 3D cubes;
extracting first image embeddings based upon the images, wherein the first image embeddings are extracted using a multimodal foundation model;
storing the first image embeddings in a vector database;
receiving an input prompt;
extracting a prompt embedding based upon the input prompt;
storing the prompt embedding in the vector database; and
identifying a similar one of the images based upon the prompt embedding, wherein identifying the similar image comprises determining a distance between the prompt embedding and each of the first image embeddings, and wherein the similar image corresponds to the first image embedding with a smallest distance.

15. The computing system of claim 14, wherein the input prompt comprises an input text query about the subsurface formation, wherein the prompt embedding comprises a text embedding when the input prompt comprises the input text query.

16. The computing system of claim 14, wherein the input prompt comprises an input 2D slice, wherein the prompt embedding comprises a second image embedding when the input prompt comprises the input 2D slice, and wherein the second image embedding is extracted using the multimodal foundation model.

17. The computing system of claim 14, wherein the operations further comprise automatically retrieving additional seismic data with seismic characteristics that are similar to seismic characteristics in the similar image, wherein the additional seismic data is automatically retrieved for further interpretation, wherein the further interpretation comprises seismic object detection, segmentation, and mapping for subsurface resources exploration and development, and wherein the additional seismic data is introduced into an image-to-text model to facilitate answering a question to provide a description of the similar image.

18. A non-transitory computer-readable medium storing instructions that, when executed by one or more processors of a computing system, cause the computing system to perform operations, the operations comprising:
receiving input data, wherein the input data comprises seismic data that represents a subsurface formation, and wherein the seismic data comprises a plurality of 2D slices or 3D cubes;
generating a plurality of images based upon the input data, wherein the images comprise 2D slices of the 3D cubes;
extracting first image embeddings based upon the images, wherein the first image embeddings are extracted using a multimodal foundation model, wherein the multimodal foundation model is fine-tuned based upon relevant domain data, and wherein the multimodal foundation model uses contrastive language-image pre-training (CLIP);
storing the first image embeddings in a vector database;
receiving an input prompt, wherein the input prompt comprises an input text query about the subsurface formation or an input 2D slice;
extracting a prompt embedding based upon the input prompt, wherein the prompt embedding comprises a text embedding when the input prompt comprises the input text query, wherein the prompt embedding comprises a second image embedding when the input prompt comprises the input 2D slice, and wherein the prompt embedding is extracted using the multimodal foundation model;
storing the prompt embedding in the vector database;
identifying a similar one of the images based upon the prompt embedding, wherein identifying the similar image comprises determining a distance between the prompt embedding and each of the first image embeddings, and wherein the similar image corresponds to the first image embedding with a smallest distance; and
automatically retrieving additional seismic data with seismic characteristics that are similar to seismic characteristics in the similar image, wherein the additional seismic data is automatically retrieved for quality control, data cleaning, further interpretation, or answering a question, wherein the further interpretation comprises seismic object detection, segmentation, and mapping for subsurface resources exploration and development, and wherein the additional seismic data is introduced into an image-to-text model to facilitate answering the question to provide a description of the similar image.

19. The non-transitory computer-readable medium of claim 18, wherein the operations further comprise performing a wellsite action in response to the similar image or the additional seismic data.

20. The non-transitory computer-readable medium of claim 19, wherein the wellsite action comprises generating and/or transmitting a signal that instructs or causes a physical action to occur at a wellsite.
